(19) United States
(12) Patent Application Publication
(10) Pub. No.: US 2026/0094283 A1
(43) Pub. Date: Apr. 2, 2026

(54) SELECTIVE MASKING IN OPTICAL FLOW BLOCK MATCHING

(71) Applicant: Arm Limited, Cambridge (GB)

(72) Inventors: Liam James O’Neil, Stretford (GB); Yanxiang Wang, Sale (GB); Carlos Barragán del Rey, Manchester (GB); Joshua James Sowerby, London (GB); Samuel James Edward Martin, Waterbeach (GB)

(21) Appl. No.: 18/902,600

(22) Filed: Sep. 30, 2024

(51) Int. Cl. G06T 7/223; G06T 3/40; G06T 7/246

(52) U.S. Cl. CPC G06T 7/223; G06T 3/40; G06T 7/248; G06T 2200/24; G06T 2207/10016; G06T 2207/10024; G06T 2207/20016

(57) ABSTRACT

An optical flow mask is generated based, at least in part, on a calculated degree of confidence of one or more motion vectors relating a prior frame and a current frame in a rendered image sequence. A pyramidal block matching algorithm is applied to calculate an optical flow relating the prior image frame and the current image frame, where applying the pyramidal block matching excludes portions of an image sequence masked by the generated optical flow mask.

### FIELD

The field relates generally to processing a rendered image sequence, and more specifically to selective masking in optical flow block matching.

### BACKGROUND

Rendering images using a computer has evolved from low-resolution, simple line drawings with limited colors made familiar by arcade games decades ago to complex, photo-realistic images that are rendered to provide content such as immersive game play, virtual reality, and high-definition CGI (Computer-Generated Imagery) movies. While some image rendering applications such as rendering a computer-generated movie can be completed over the course of many days, other applications such as video games and virtual reality or augmented reality may entail real-time rendering of relevant image content. Because computational complexity may increase with the degree of realism desired, efficient rendering of real-time content while providing acceptable image quality is an ongoing technical challenge.

Producing realistic computer-generated images typically involves a variety of image rendering techniques, from rendering perspective of the viewer correctly, rendering different surface textures, and providing realistic lighting. But rendering an accurate image takes significant computing resources, and becomes more difficult when the rendering must be completed many tens to hundreds of times per second to produce desired framerates for game play, augmented reality, or other applications. Specialized graphics rending pipelines can help manage the computational workload, providing a balance between image quality and rendered images or frames per second using techniques such as taking advantage of the history of a rendered image to improve texture rendering. Rendered objects that are small or distant may be rendered using fewer triangles than objects that are close, and other compromises between rendering speed and quality can be employed to provide the desired balance between frame rate and image quality.

In some embodiments, an entire image may be rendered at a lower resolution than the eventual display resolution, significantly reducing the computational burden in rendering the image. In other examples, the number of frames rendered may be less than the number of frames presented for display, such as rendering at 60 frames per second while displaying images on a display with a refresh rate of 120 frames per second. As developers often choose to use advances in rendering and graphics processing unit (GPU) technology to produce higher-resolution images with enhancements such as ray tracing to improve the fidelity or visual quality of rendered images, frame rates of mobile games and other applications often do not keep pace with advances in display technology.

Some rendering systems therefore attempt to increase the perceived frame rate of rendered image sequences such as by interpolating between rendered image frames. But, generating an additional frame that exists between two previously-rendered frames in time is not an easy task, should desirably be performed with significantly less computational burden than actually rendering the additional frame for the interpolation process to be useful. Further, solutions that may work on desktop computers or video game consoles having high bandwidth and high power budgets may not be well-suited to portable or mobile devices such as smartphones or tablet computers.

For reasons such as these, it is desirable to perform frame interpolation for rendered image streams in a way that is computationally efficient and power efficient.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 shows an image frame diagram illustrating interpolation between consecutive rendered image frames, consistent with an example embodiment.

FIG. 2 is a block diagram showing pyramidal block matching to generate optical flow vectors, consistent with an example embodiment.

FIG. 3 is a pseudocode listing of a method of generating an optical flow mask, consistent with an example embodiment.

FIG. 4 shows an optical flow mask, consistent with an example embodiment.

FIG. 5 is a flow diagram of a method of using an optical flow mask in performing pyramidal block matching to calculate optical flow, consistent with an example embodiment.

FIG. 6 is a schematic diagram of a neural network, consistent with an example embodiment.

FIG. 7 shows a computing environment in which one or more image processing and/or filtering architectures may be employed, consistent with an example embodiment.

FIG. 8 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As graphics processing power available to smart phones, personal computers, and other such devices continues to grow, computer-rendered images continue to become increasingly realistic in appearance. These advances have enabled real-time rendering of complex images in sequential image streams, such as may be seen in games, augmented reality, and other such applications, but typically still involve significant constraints or limitations based on the graphics processing power available. For example, images may be rendered at a lower resolution than the eventual desired display resolution, with the render resolution based on the desired image or frame rate, the processing power available, the level of image quality acceptable for the application, and other such factors. Many developers elect to use available graphics resources to render with a high fidelity visual quality or resolution, compromising in other areas such as frame rate (or the number of frames rendered per unit of time). Many computer graphics applications such as advanced games therefore look substantially better than a decade ago, but do not make use of recent advances in display refresh rates.

Some approaches to addressing problems such as these may involve interpolating between rendered frames using an algorithm that is more computationally efficient than rendering the interpolated frame. Interpolation between rendered frames may be somewhat complex in that rendered objects may be moving not only side to side or up and down, but may also be moving toward or away from the viewer's vantage point (e.g., a rendered object may be changing in apparent size), may be accelerating, or may have shadows or other lighting effects not captured by motion vectors associated with the rendered objects. For reasons such as these, rendered frame interpolation algorithms have largely focused on desktop computer-grade high-performance and high-power discrete GPU devices, and are not low-power or mobile device-friendly.

Some examples presented herein therefore various methods of masking calculation of optical flow between rendered image frames to reduce the amount of calculations performed, such as by using a mask to define a limited area of an image in which optical flow is calculated. The mask in some such embodiments is based on a confidence level of motion vectors in the rendered image sequence, such as calculating optical flow only in areas where motion vector confidence is low. In a further example, large changes in RGB color that do not correspond to large changes in object depth may indicate such a low degree of confidence in motion vectors, such as where lighting effects, particle effects such as smoke, or the like are present.

In one such example, an optical flow mask is generated based, at least in part, on a calculated degree of confidence of one or more motion vectors relating a prior frame and a current frame in a rendered image sequence. Pyramidal block matching is applied to calculate an optical flow relating the prior image frame and the current image frame, wherein applying the pyramidal block matching excludes portions of an image sequence masked by the generated optical flow mask. In a further example, the pyramidal block matching comprises creating a pyramid of consecutively downsampled prior image frames, and creating a pyramid of consecutively downsampled current image frames corresponding to the pyramid of consecutively downsampled prior image frames. Block matching is performed on a lowest resolution downsampled prior image frame and a lowest resolution downsampled current image frame, and block matching is iteratively performed on consecutively higher resolution downsampled prior image frames and current image frames using block matching over corresponding smaller block matching search spaces not covered by prior lower resolution block matching iterations.

In another example, an optical flow mask is generated by warping color parameters and depth parameters from the prior frame into the current frame. A color difference mask is created based, at least in part, on differences between warped color parameters from the prior frame and color parameters from the current frame, and a depth difference mask is created based, at least in part, on differences between the warped depth parameters from the previous frame and depth parameters from the current frame. The depth difference mask and the color difference mask are converted to binary masks, and a difference between the depth difference mask and the color difference mask is calculated to generate the optical flow mask.

Examples such as these can use optical flow masks to reduce the area of a rendered image or rendered image sequence over which optical flow is calculated, such as in performing frame interpolation, thereby reducing the computational workload and time required to generate an interpolated image frame while retaining high image quality

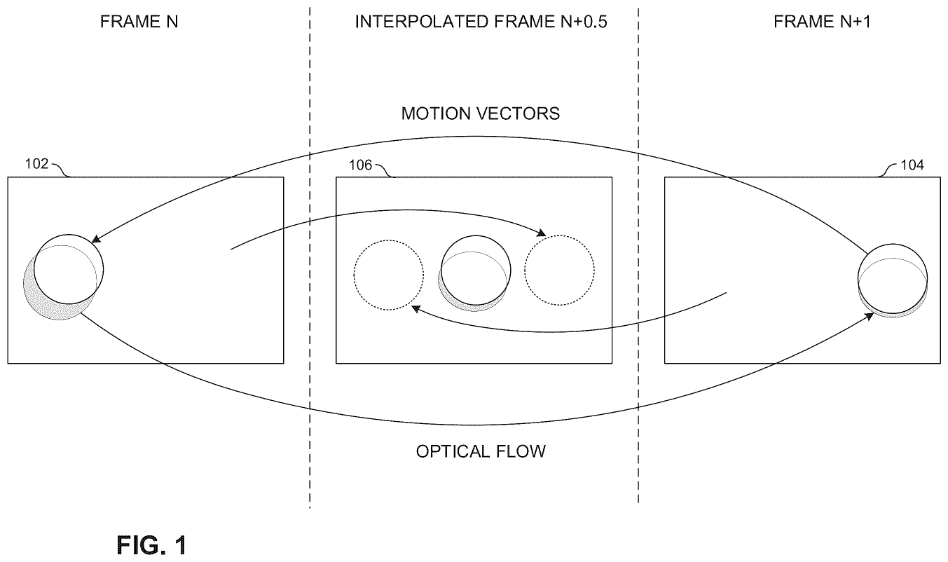

FIG. 1 shows an image frame diagram illustrating interpolation between consecutive rendered image frames, consistent with an example embodiment. Here, consecutive image frames N and N+1 are shown at 102 and 104, respectively. To increase the apparent frame rate of the rendered image stream, an interpolated image frame N+0.5 is generated as shown at 106. In this example, a single interpolated image frame is shown at a time centered between image frame N and image frame N+1, while other embodiments may include multiple interpolated image frames between rendered image frames, interpolated image frames spaced at intervals other than a whole-number multiple of the original image frame rate, or the like.

The interpolated image frame shown at 106 in this example reflects that the position of a round object, such as a ball, has moved to the right approximately half the distance of its movement between sequentially rendered image frames 102 and 104. In further examples, the movement of at least some objects between rendered image frames may further account for acceleration, such that the object may be placed somewhere other than the midpoint between its position in the frames preceding and following the interpolated frame.

The example interpolated frame 106 further illustrates how certain areas of the frame are disoccluded or no longer covered by the rendered ball object, resulting in the background or other rendered objects having greater depth becoming visible between frames due to the ball's movement. This is reflected by the balls in interpolated frame 106 shown using dashed lines, with arrows reflecting that these disoccluded areas may be selectively copied from the same areas of frames 102 and 104.

If the perspective of the camera changes between image frames or objects otherwise move between sequential image frames, the image frames may be warped in generating effects such as interpolation, disocclusion, and the like. In a simplified example, if the camera is panning to the right between frames 102 and 104 of the example of FIG. 1, this panning will desirably be accounted for in copying disoccluded elements of the background, illumination, or other objects into interpolated frame 106.

Motion vectors associated with objects such as the rendered ball of FIG. 1 may be used to help form an interpolated image of the ball or other objects such as in interpolated image frame 106, but may not account for differences in illumination, shadows, and other such features. Features such as the shadow behind the rendered ball may be tracked separately from motion vectors in some examples using optical flow, which may track the movement of various features of an image across sequential image frames without prior knowledge of the objects rendered in the frames. While optical flow may be similar in some ways to motion vectors in that it tracks movement in image sequences, it may be less precise than tracking rendered objects. Although optical flow may be somewhat less accurate, it may produce visibly better tracking of things like lighting and particle effects that are not rendered objects having associated motion vectors.

Motion vectors in the example of FIG. 1 are calculated from the perspective of the most recently-rendered frame, shown at 104, looking back to the preceding rendered frame 102, as shown by the motion vectors line and arrow near the top of FIG. 1. The rendering engine has knowledge of both the current frame (e.g. frame 104) and the prior rendered frame, and so can calculate the most up-to-date motion vectors looking back from the previous frame. Optical flow, in this example, may be calculated looking forward from a past frame to the current frame as represented by the optical flow line and arrow near the bottom of FIG. 1.

In further examples, the motion vectors and/or optical flow may be scattered or pushed into the interpolated frame, using a depth buffer to resolve write collisions where multiple vectors are written to the same interpolated pixel location and interpolation to fill unfilled interpolated pixel locations. Color information for the interpolated frame may then be gathered using depth information along with motion vectors and optical flow in the interpolated frame to create candidate interpolated frames, including in various examples interpolated motion vector color frames based on the preceding (Frame N) and following (Frame N+1) frames, and optical flow color frames based on the preceding (Frame N) and following (Frame N+1) frames. Selection from among these interpolated frame colors may be made on a pixel-by-pixel basis (or at reduced resolution) using a trained neural network, or other such methods, to create a displayed interpolated frame N+0.5.

Calculation of the interpolated motion vector and color candidate frames, including scattering the motion vectors, optical flow, and depth information into the interpolated frame and using depth and color information to construct the candidate interpolated frames is computationally expensive, and masking or reducing the image area over which at least some operations such as optical flow vector calculation, scattering, and gathering are performed may significantly increase performance and/or visual quality of the interpolated frame.

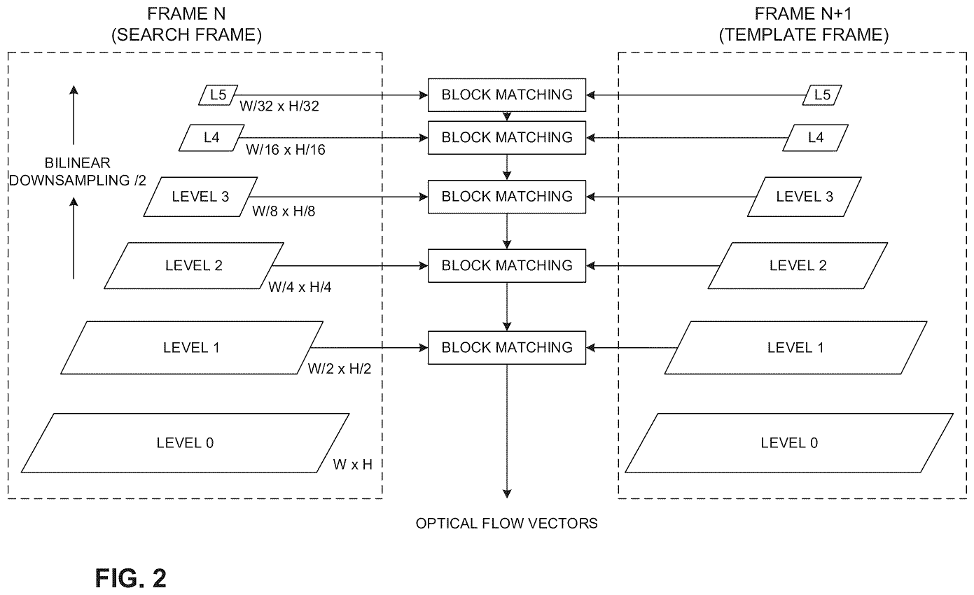

FIG. 2 is a block diagram showing pyramidal block matching to generate optical flow vectors, consistent with an example embodiment. Here, Frame N and Frame N+1 correspond to the frames preceding and following an interpolated frame, as in the example of FIG. 1. These original-resolution frames are shown as Level 0, near the bottom of the respective image frame pyramids. Each of these frames is bilinearly downsampled to half its original vertical and horizontal resolution to create Level 1 downsampled frames having reduced resolution, and this process is repeated on the Level 1 frames to generate Level 2 frames having a further reduced (one quarter the original vertical and horizontal resolution) resolution. This downsampling process is repeated to create consecutively downsampled image frames until Level 5, which is 1/32 the original width and height of the original image frame at Level 0, creating downsampled image pyramids for both preceding Frame N and following Frame N+1.

Calculation of optical flow may involve block matching a portion of one image, such as the following Frame N+1 (also called a template frame), with a portion of a second image in the same image stream, such as preceding Frame N (also called a search frame). A match may be determined by finding a lowest error or an error meeting a desired threshold in matching a block from the template frame with a block in the search frame, with the result reflected as an optical flow vector pointing from the block location in the template frame to the matched block location in the search frame. The resulting optical flow vectors may therefore be used to track non-rendered image features such as lighting effects where motion vectors for rendered objects are not available or do not correctly indicate image features such as lighting effects.

To reduce the computational burden of attempting to match each block within the template frame to a block within the search frame, various methods may be employed such as reducing the search area in the search frame over which a search is conducted or performing block matching using a reduced resolution version of the image as shown in the image pyramids of FIG. 2. Because the computational burden of performing block matching scales quadratically with the resolution of the image frames, block matching may be performed on a reduced resolution image frame as is shown in the pyramid image frame structure of FIG. 2. By block matching starting with the lowest resolution image frames (e.g., Level 5 of FIG. 2), the block matching algorithm may work more quickly and efficiently than the same algorithm applied to the original resolution image at Level 0. Optical flow vectors may then be refined using successively higher resolution levels in the search pyramid, with search spaces for each successive higher resolution level approximately limited to the change in resolution between successive pyramid levels. In a further example, optical flow vectors need not be refined using every layer of the downsampled image pyramids, such as where optical flow and motion vector estimation are applied at a quarter resolution or are used to generate a reduced resolution interpolated frame. In the example of FIG. 2, optical flow vectors need not be refined past a quarter resolution of the original image frames, as reflected by the Level 1 downsampled template and search frames.

The resolution of the original template and search frames, the number of layers of the block matching pyramid, the size of a tile, and the range or neighborhood of tiles to search in the search frame are examples of parameters that may be adjusted to achieve a desired tradeoff between image accuracy and computational workload. Some embodiments described herein provide for reduced computational workload while maintaining a higher degree of image accuracy by reducing or masking the areas of an image over which optical flow is calculated, such as by masking based on a confidence level of motion vectors in the rendered image sequence and calculating optical flow only in areas where motion vector confidence is low. Large changes in RGB color that do not correspond to large changes in object depth may indicate such a low degree of confidence in motion vectors, such as where lighting effects, particle effects such as smoke, or the like are present.

In a more detailed example, an optical flow mask may be generated by warping color parameters and depth parameters from the preceding frame or search frame into the following frame or template frame. A color difference mask is created based, at least in part, on differences between warped color parameters from the preceding frame and color parameters from the following frame, and a depth difference mask is created based, at least in part, on differences between the warped depth parameters from the preceding frame and depth parameters from the following frame. The depth difference mask and the color difference mask are converted to binary masks, and a difference between the depth difference mask and the color difference mask is calculated to generate the optical flow mask. The optical flow mask may then be used to limit the areas in which optical flow is calculated in processes such as pyramidal block matching for interpolating rendered image frames.

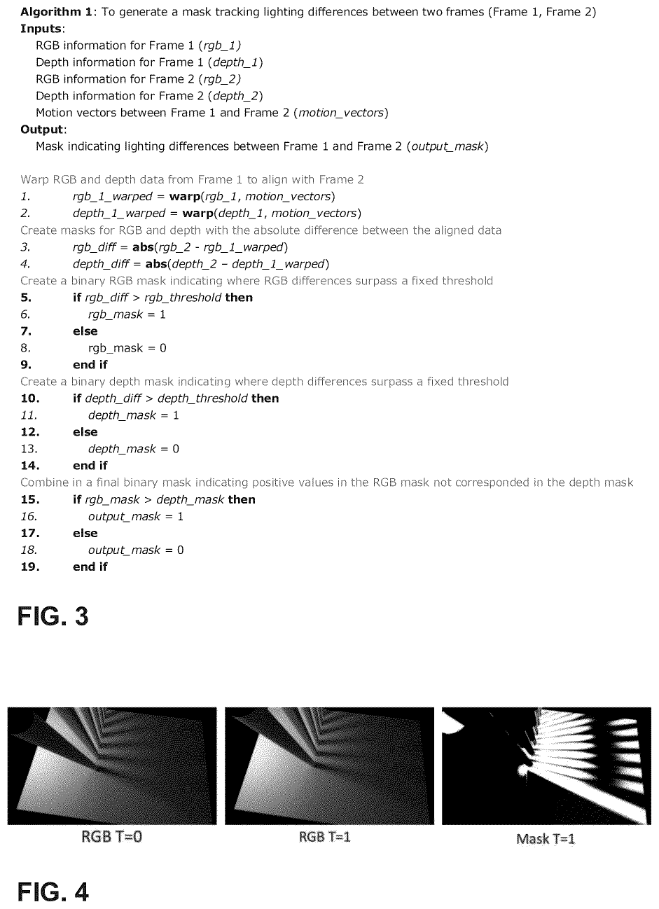

FIG. 3 is a pseudocode listing of a method of generating an optical flow mask, consistent with an example embodiment. Here, the algorithm observes lighting differences between two consecutive rendered image frames (Frame 1 and Frame 2) using RGB color information and depth information for both image frames, and motion vectors describing rendered object movement between the two frames. The algorithm outputs a bit mask indicating lighting differences between Frame 1 and Frame 2, such that optical flow need only be calculated for portions of the image frames in which lighting differences are observed.

The algorithm begins in lines 1-2 by warping the RGB and depth information from Frame 1 to align with Frame 2, using motion vectors to create warped versions of the RGB and depth information for Frame 1. Absolute difference values between the warped Frame 1 and the original Frame 2 image data are then computed at lines 3-4, and are subsequently used to create binary masks indicating where these differences exceed a threshold value on a pixel-by-pixel basis. Lines 5-9 describe how a binary mask is created indicating whether the absolute difference value in RGB color values exceeds a threshold amount (having a one value if the difference threshold is exceeded), and lines 10-14 similarly describe how a binary mask is created indicating whether the depth difference exceeds a threshold amount (having a one value if the difference threshold is exceeded). Lines 15-19 create an output mask having a one value only in places where the RGB color difference is a one value (or exceeds the difference threshold), but the depth difference has a zero value (or does not exceed the threshold), indicating the observed change in RGB color value is more likely the result of a change in lighting than a disocclusion or other rendered object motion artifact.

The algorithm described in FIG. 3 may be applied to mask optical flow calculation in various embodiments, including calculating optical flow between two image frames or using a pyramidal block matching process such as that shown in the example of FIG. 2. The algorithm outputs a mask value indicating where significant differences in RGB color value have occurred but significant differences in depth have not when comparing a warped rendered image frame with a sequential reference rendered image frame, suggesting a difference in lighting or other optical effect such as smoke that may not be captured by rendered object motion vectors.

FIG. 4 shows an optical flow mask, consistent with an example embodiment. Here, sequential rendered images shown as RGB images at time T=0 and T=1 are shown, along with a mask at T=1, derived from RGB and depth differences between the T=1 frame and a T=0 image frame warped (such as by using motion vectors) to match the T=1 image frame. The mask shown at T=1 may be derived using a method such as the algorithm example of FIG. 3, and has a zero (shown as black) value in areas where optical flow should not be calculated and a one (shown as white) value in image regions where optical flow should be calculated.

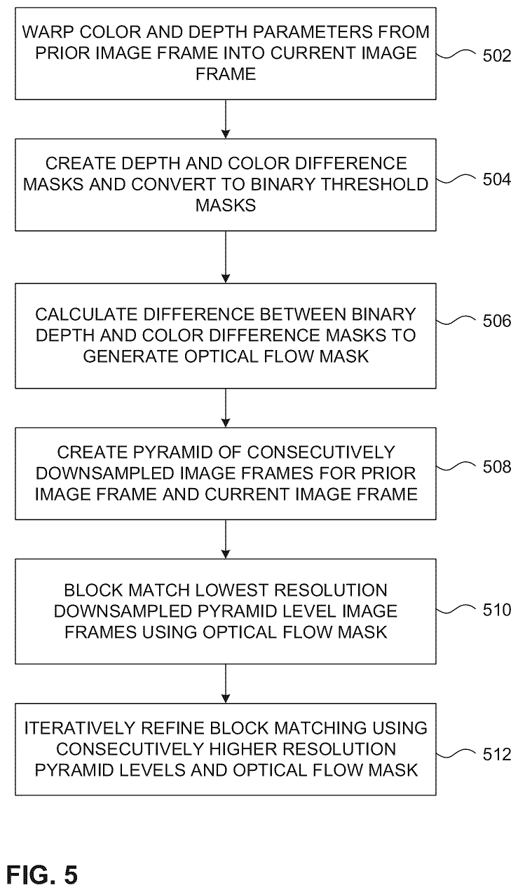

FIG. 5 is a flow diagram of a method of using an optical flow mask in performing pyramidal block matching to calculate optical flow, consistent with an example embodiment. The first steps in the flow diagram describe calculating an optical flow mask, including warping color and depth parameters from a prior image frame to align with a current image frame at 502. The absolute value of the color difference from the prior warped frame and the current frame is calculated at 504 on a per-pixel basis, along with the absolute value of the depth difference on a per-pixel basis. These absolute value masks are then converted into binary masks by determining whether the mask value exceeds a threshold value, such that the binary color difference mask holds a one value only where the absolute difference value between the prior warped frame color and the current frame color exceeds a threshold value, and the binary depth mask holds a one value only where the absolute difference value between the prior warped frame depth and the current frame depth exceeds a threshold value. The difference between the binary depth and color difference masks is calculated at 506 to generate an optical flow mask, such as by assigning a one value to the optical flow mask only at pixel locations where the binary color value for the pixel has a one value (i.e., exceeds the color threshold) but the binary depth value for the pixel has a zero value (i.e., does not exceed the depth threshold). A one value in the optical flow mask therefore indicates pixel locations where the RGB color difference between a warped prior image frame and a current frame is relatively large but the depth difference is not, suggesting a change in lighting effect between the two image frames such as a moved shadow.

In some examples, optical flow is only calculated for those areas of an image frame where such an optical flow mask has a one value. The mask may be downsampled along with the image frames for pyramid block matching as shown and described in FIG. 2, or may be downsampled to be used for optical flow calculation at a reduced resolution such as where computing resources are constrained. In examples where optical flow information is desired for the whole image frame, such as where the optical flow frame is used as an input to a neural network or may be used to blend an optical flow-derived image frame with other image frames for interpolation, coarser or faster optical flow calculations may be performed for masked areas of the image frame, such as performing block matching calculation of optical flow vectors only at one or more lower resolution levels during pyramidal block matching. Other tunable block matching parameters, such as block size, search radius, and the like may be similarly adjusted based on whether the optical flow mask contains a one or zero value.

In one such example, a pyramid of consecutively downsampled image frames is generated for the prior image frame and the current image frame at 508. In a further example, the corresponding optical flow mask is further downsampled to form an optical flow mask pyramid corresponding to the downsampled image pyramids. Block matching is performed at a low resolution level of the pyramid at 510, such as the lowest resolution level of the pyramid, using the optical flow mask to limit block matching to areas of the downsampled images where a “one” value is present in the optical flow mask. In an alternate embodiment, optical flow may be calculated for the entire lowest resolution level of the pyramid, but may be curtailed at higher resolution levels of the pyramid or other parameters may be adjusted based on the optical flow mask. In the example of FIG. 5, block matching and optical flow calculation continues iteratively using consecutively higher resolution pyramid levels and optical flow masks, refining the optical flow calculations made at lower resolution levels of the block matching pyramid. As is shown in the example of FIG. 2, iterative block matching to refine optical flow vectors at consecutively lower levels (i.e. higher resolutions) in the block matching pyramid may conclude before the final, highest resolution layer of the pyramid, such as where motion vectors and optical flow are only needed at a half-width and half-height resolution relative to the original image frames. In further examples, optical flow vector interpolation, smoothing, subpixel, or other such effects may be applied to the optical flow vectors, either throughout the optical flow vector frame or in specific areas of the optical vector flow frame indicated by the optical flow mask.

Methods and systems such as those described in these examples may generate optical flow vectors between sequential rendered image frames more efficiently than other methods, enabling devices with limited computing resources to generate higher quality images using optical flow such as image frame interpolation. By limiting more computationally optical flow calculations to areas of an image where optical flow is likely to be relevant using an optical mask, the saved compute time can be allocated to other image processing functions and increase the overall accuracy of the processed image.

Various parameters in the examples presented herein, such as pyramidal block matching parameters including block size, search space, and the number of layers in a block matching pyramid may be tuned or adjusted based on factors such as the preceding and current image frames and the optical flow mask. Some sequential image processing systems may also employ blending coefficients used in blending optical flow-derived interpolated images and motion vector-derived interpolated images, and other such parameters. Various parameters such as these may be determined in some examples using machine learning techniques such as a trained neural network. In some examples, a neural network may comprise a graph comprising nodes to model neurons in a brain. In this context, a “neural network” means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

In one example embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

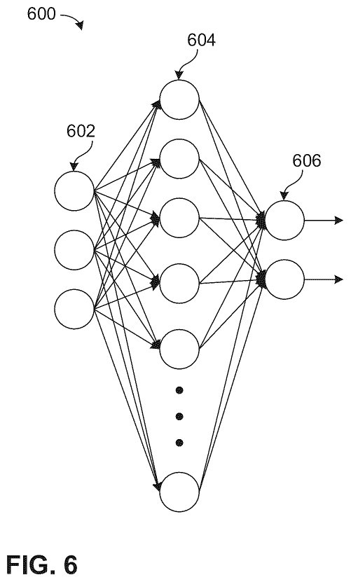

FIG. 6 is a schematic diagram of a neural network 600 formed in “layers” in which an initial layer is formed by nodes 602 and a final layer is formed by nodes 606. All or a portion of features of neural network 600 may be implemented various embodiments of systems described herein. Neural network 600 may include one or more intermediate layers, shown here by intermediate layer of nodes 604. Edges shown between nodes 602 and 604 illustrate signal flow from an initial layer to an intermediate layer. Likewise, edges shown between nodes 604 and 606 illustrate signal flow from an intermediate layer to a final layer. Although FIG. 6 shows each node in a layer connected with each node in a prior or subsequent layer to which the layer is connected, i.e., the nodes are fully connected, other neural networks will not be fully connected but will employ different node connection structures. While neural network 600 shows a single intermediate layer formed by nodes 604, other implementations of a neural network may include multiple intermediate layers formed between an initial layer and a final layer.

According to an embodiment, a node 602, 604 and/or 606 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation. The neural networks employed in various examples can be any known or future neural network architecture, including traditional feed-forward neural networks, convolutional neural networks, or other such networks.

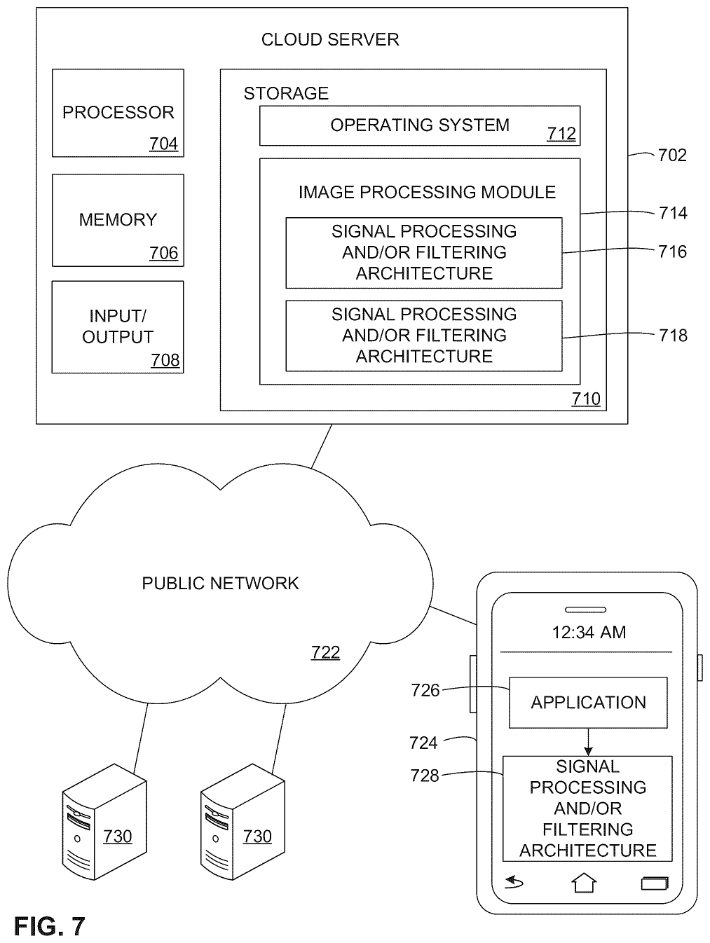

FIG. 7 shows a computing environment in which one or more image processing and/or filtering architectures (e.g., image processing stages, FIGS. 2 and 3A-3B) may be employed, consistent with an example embodiment. Here, a cloud server 702 includes a processor 704 operable to process stored computer instructions, a memory 706 operable to store computer instructions, values, symbols, parameters, etc., for processing on the cloud server, and input/output 708 such as network connections, wireless connections, and connections to accessories such as keyboards and the like. Storage 710 may be nonvolatile, and may store values, parameters, symbols, content, code, etc., such as code for an operating system 712 and code for software such as image processing module 714. Image processing module 714 may comprise multiple signal processing and/or filtering architectures 716 and 718, which may be operable to render and/or process images. Signal processing and/or filtering architectures may be available for processing images or other content stored on a server, or for providing remote service or “cloud” service to remote computers such as computers 730 connected via a public network 722 such as the Internet.

Smartphone 724 may also be coupled to a public network in the example of FIG. 7, and may include an application 726 that utilizes image processing and/or filtering architecture 728 for processing rendered images such as a video game, virtual reality application, or other application 726. Image processing and/or filtering architectures 716, 718, and 728 may provide faster and more efficient computation of effects such as interpolating between frames of a rendered image sequence in an environment such as a smartphone, and can provide for longer battery life due to reduction in power needed to impart a desired effect and/or compute a result. In some examples, a device such as smartphone 724 may use a dedicated signal processing and/or filtering architecture 728 for some tasks, such as relatively simple image rendering or processing that does not require substantial computational resources or electrical power, and offloads other processing tasks to a signal processing and/or filtering architecture 716 or 718 of cloud server 702 for more complex tasks.

Signal processing and/or filtering architectures 716, 718, and 728 of FIG. 7 may, in some examples, be implemented in software, where various nodes, tensors, and other elements of processing stages (e.g., processing blocks in FIG. 1) may be stored in data structures in a memory such as 706 or storage 710. In other examples, signal processing and/or filtering architectures 716, 718, and 728 may be implemented in hardware, such as a neural network structure that is embodied within the transistors, resistors, and other elements of an integrated circuit. In an alternate example, signal processing and/or filtering architectures 716, 718 and 728 may be implemented in a combination of hardware and software, such as a neural processing unit (NPU) having software-configurable weights, network size and/or structure, and other such configuration parameters.

Trained neural networks may be formed in whole or in part by and/or expressed in transistors and/or lower metal interconnects (not shown) in processes (e.g., front end-of-line and/or back-end-of-line processes) such as processes to form complementary metal oxide semiconductor (CMOS) circuitry. The various blocks, neural networks, and other elements disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

Computing devices such as cloud server 702, smartphone 724, and other such devices that may employ signal processing and/or filtering architectures can take many forms and can include many features or functions including those already described and those not described herein.

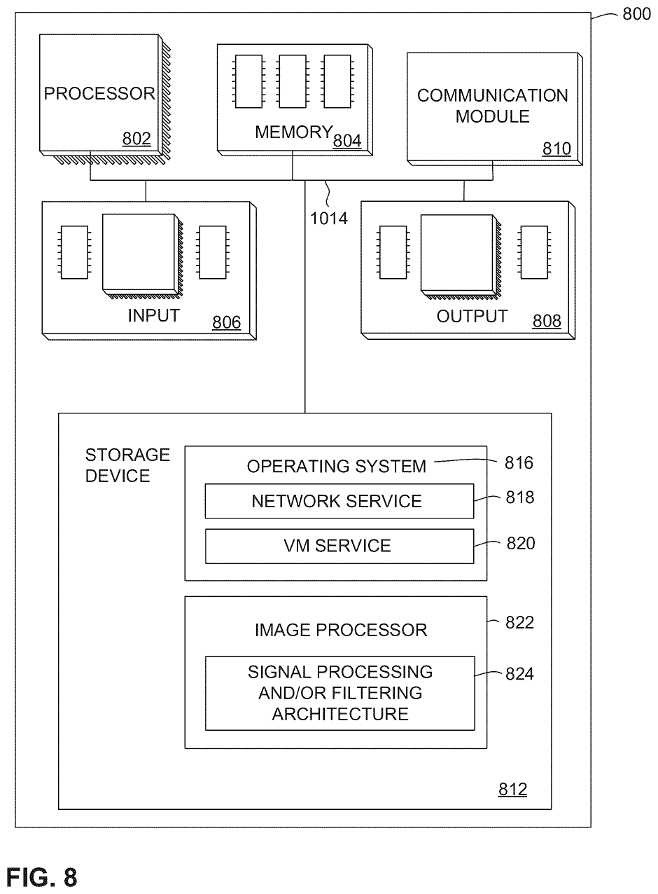

FIG. 8 shows a block diagram of a general-purpose computerized system, consistent with an example embodiment. FIG. 8 illustrates only one particular example of computing device 800, and other computing devices 800 may be used in other embodiments. Although computing device 800 is shown as a standalone computing device, computing device 800 may be any component or system that includes one or more processors or another suitable computing environment for executing software instructions in other examples, and need not include all of the elements shown here.

As shown in the specific example of FIG. 8, computing device 800 includes one or more processors 802, memory 804, one or more input devices 806, one or more output devices 808, one or more communication modules 810, and one or more storage devices 812. Computing device 800, in one example, further includes an operating system 816 executable by computing device 800. The operating system includes in various examples services such as a network service 818 and a virtual machine service 820 such as a virtual server. One or more applications, such as image processor 822 are also stored on storage device 812, and are executable by computing device 800.

Each of components 802, 804, 806, 808, 810, and 812 may be interconnected (physically, communicatively, and/or operatively) for inter-component communications, such as via one or more communications channels 814. In some examples, communication channels 814 include a system bus, network connection, inter-processor communication network, or any other channel for communicating data. Applications such as image processor 822 and operating system 816 may also communicate information with one another as well as with other components in computing device 800.

Processors 802, in one example, are configured to implement functionality and/or process instructions for execution within computing device 800. For example, processors 802 may be capable of processing instructions stored in storage device 812 or memory 804. Examples of processors 1002 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 812 may be configured to store information within computing device 800 during operation. Storage device 812, in some examples, is known as a computer-readable storage medium. In some examples, storage device 812 comprises temporary memory, meaning that a primary purpose of storage device 812 is not long-term storage. Storage device 812 in some examples is a volatile memory, meaning that storage device 812 does not maintain stored contents when computing device 800 is turned off. In other examples, data is loaded from storage device 812 into memory 804 during operation. Examples of volatile memories include random access memories (RAM), dynamic random access memories (DRAM), static random access memories (SRAM), and other forms of volatile memories known in the art. In some examples, storage device 812 is used to store program instructions for execution by processors 802. Storage device 812 and memory 804, in various examples, are used by software or applications running on computing device 800 such as image processor 1022 to temporarily store information during program execution.

Storage device 812, in some examples, includes one or more computer-readable storage media that may be configured to store larger amounts of information than volatile memory. Storage device 812 may further be configured for long-term storage of information. In some examples, storage devices 812 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 800, in some examples, also includes one or more communication modules 810. Computing device 800 in one example uses communication module 810 to communicate with external devices via one or more networks, such as one or more wireless networks. Communication module 810 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 800 uses communication module 810 to wirelessly communicate with an external device such as via public network 722 of FIG. 7.

Computing device 800 also includes in one example one or more input devices 806. Input device 806, in some examples, is configured to receive input from a user through tactile, audio, or video input. Examples of input device 806 include a touchscreen display, a mouse, a keyboard, a voice responsive system, video camera, microphone or any other type of device for detecting input from a user.

One or more output devices 808 may also be included in computing device 800. Output device 808, in some examples, is configured to provide output to a user using tactile, audio, or video stimuli. Output device 808, in one example, includes a display, a sound card, a video graphics adapter card, or any other type of device for converting a signal into an appropriate form understandable to humans or machines. Additional examples of output device 808 include a speaker, a light-emitting diode (LED) display, a liquid crystal display (LCD or OLED), or any other type of device that can generate output to a user.

Computing device 800 may include operating system 816. Operating system 816, in some examples, controls the operation of components of computing device 800, and provides an interface from various applications such as image processor 822 to components of computing device 800. For example, operating system 816, in one example, facilitates the communication of various applications such as image processor 822 with processors 802, communication unit 810, storage device 812, input device 806, and output device 808. Applications such as image processor 822 may include program instructions and/or data that are executable by computing device 800. As one example, image processor 822 may implement a signal processing and/or filtering architecture 824 to perform image processing tasks or rendered image processing tasks such as those described above, which in a further example comprises using signal processing and/or filtering hardware elements such as those described in the above examples. These and other program instructions or modules may include instructions that cause computing device 800 to perform one or more of the other operations and actions described in the examples presented herein.

Features of example computing devices in FIGS. 7 and 8 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in the figures and text associated with the foregoing figures of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A method, comprising:
generating an optical flow mask based, at least in part, on a calculated degree of confidence of one or more motion vectors relating a prior frame and a current frame in a rendered image sequence; and
applying a pyramidal block matching to calculate an optical flow relating the prior image frame and the current image frame, wherein applying the pyramidal block matching comprises applying the pyramidal block matching differently for portions of an image sequence masked by the generated optical flow mask.

2. The method of claim 1, wherein applying the pyramidal block matching differently for portions of an image sequence masked by the generated optical flow mask comprises excluding the portions of the image sequence masked by the generated optical flow mask from applying pyramidal block matching.

3. The method of claim 1, wherein the calculated degree of confidence expresses a lower degree of confidence for lighting effects, particle effects, animated textures, or a combination thereof.

4. The method of claim 1, wherein generating the optical flow mask further comprises masking one or more areas of the rendered image sequence comprising user interface graphics.

5. The method of claim 1, wherein generating the optical flow mask further comprises:
warping color parameters and depth parameters from the prior frame into the current frame;
creating a color difference mask based, at least in part, on differences between warped color parameters from the prior frame and color parameters from the current frame;
creating a depth difference mask based, at least in part, on differences between the warped depth parameters from the prior frame and depth parameters from the current frame;
converting the depth difference mask and the color difference mask to binary masks; and
calculating a difference between the depth difference mask and the color difference mask to generate the optical flow mask.

6. The method of claim 1, wherein the pyramidal block matching comprises:
creating a pyramid of consecutively downsampled prior image frames;
creating a pyramid of consecutively downsampled current image frames corresponding to the pyramid of consecutively downsampled prior image frames;
block matching a lowest resolution downsampled prior image frame and a lowest resolution downsampled current image frame; and
iteratively block matching consecutively higher resolution downsampled prior image frames and current image frames using block matching over corresponding smaller block matching search spaces not covered by prior lower resolution block matching iterations.

7. The method of claim 6, wherein a number of pyramid layers, a number of tiles to search or a size of a search tile, or a combination thereof, are configurable parameters that may be selected to achieve a desired compute time, a maximum detectable optical flow vector length, or a confidence level in optical flow matches, or a combination thereof.

8. The method of claim 7, wherein the number of pyramid layers, the number of tiles to search or the size of a search tile, or a combination thereof, may be varied across different areas of the current frame or across different levels of the pyramid of image frames used in pyramidal block matching, or a combination thereof.

9. The method of claim 1, further comprising generating an optical flow mask for each level of a rendered image pyramid in pyramidal block matching, and using the optical flow mask corresponding to each level of the rendered image pyramid to applying the pyramidal block matching differently for portions of an image sequence masked by the generated optical flow mask.

10. A computing device, comprising:
a memory comprising one more storage devices; and
one or more processors coupled to the memory, the one or more processors operable to execute instructions stored in the memory to, for a rendered image sequence:
generate an optical flow mask based, at least in part, on a calculated degree of confidence of one or more motion vectors relating a prior frame and a current frame in a rendered image sequence;
applying a pyramidal block matching to calculate an optical flow relating the prior frame and the current frame, wherein applying the pyramidal block matching comprises applying the pyramidal block matching differently for portions of an image sequence masked by the generated optical flow mask.

11. The computing device of claim 10, wherein applying the pyramidal block matching differently for portions of an image sequence masked by the generated optical flow mask comprises excluding the portions of the image sequence masked by the generated optical flow mask from applying pyramidal block matching.

12. The computing device of claim 10, wherein the calculated degree of confidence expresses a lower degree of confidence for lighting effects or particle effects, or a combination thereof.

13. The computing device of claim 10, wherein generating the optical flow mask further comprises masking one or more areas of the rendered image sequence comprising user interface graphics.

14. The computing device of claim 10, wherein the optical flow mask is further generated by:
warping color parameters and depth parameters from the prior frame into the current frame;
creating a color difference mask based, at least in part, on differences between warped color parameters from the prior frame and color parameters from the current frame;
creating a depth difference mask based, at least in part, on differences between the warped depth parameters from the prior frame and depth parameters from the current frame;
converting the depth difference mask and the color difference mask to binary masks; and
calculating a difference between the depth difference mask and the color difference mask to generate the optical flow mask.

15. The computing device of claim 10, wherein pyramidal block matching comprises:
creating a pyramid of consecutively downsampled prior image frames;
creating a pyramid of consecutively downsampled current image frames corresponding to the pyramid of consecutively downsampled prior image frames;
block matching a lowest resolution downsampled prior image frame and a lowest resolution downsampled current image frame; and
iteratively block matching consecutively higher resolution downsampled prior image frames and current image frames using block matching over corresponding smaller block matching search spaces not covered by prior lower resolution block matching iterations.

16. The computing device of claim 15, wherein at least one of a number of pyramid layers, a number of tiles to search, or a size of a search tile, or a combination thereof, are configurable parameters that may be selected to achieve a desired compute time, a maximum detectable optical flow vector length, or a confidence level in optical flow matches, or a combination thereof.

17. The computing device of claim 16, wherein the number of pyramid layers, the number of tiles to search, or the size of a search tile, or a combination thereof, may be varied across different areas of the current frame, or across different levels of the pyramid layers used in pyramidal block matching, or a combination thereof.

18. The computing device of claim 10, further comprising generating an optical flow mask for each level of a rendered image pyramid in pyramidal block matching, and using the optical flow mask corresponding to each level of the rendered image pyramid to apply the pyramidal block matching differently for portions of an image sequence masked by the generated optical flow mask.

19. A method of generating an optical flow mask for use in indicating areas of an image for which optical flow is to be calculated by:
warping color parameters and depth parameters from a prior frame into a current frame;
creating a color difference mask based, at least in part, on differences between warped color parameters from the prior frame and color parameters from the current frame;
creating a depth difference mask based, at least in part, on differences between the warped depth parameters from the prior frame and depth parameters from the current frame;
converting the depth difference mask and the color difference mask to binary masks; and
calculating a difference between the depth difference mask and the color difference mask to generate the optical flow mask.

20. The method of claim 19, further comprising using the optical flow mask to selectively mask one or more layers of pyramidal block matching in an optical flow computation by:
creating a pyramid of consecutively downsampled prior image frames;
creating a pyramid of consecutively downsampled current image frames corresponding to the pyramid of consecutively downsampled prior image frames;
block matching a lowest resolution downsampled prior image frame and a lowest resolution downsampled current image frame; and
iteratively block matching consecutively higher resolution downsampled prior image frames and current image frames using block matching over corresponding smaller block matching search spaces not covered by prior lower resolution block matching iterations.
